(19) United States
(12) Patent Application Publication
(10) Pub. No.: US 2013/0343662 A1
(43) Pub. Date: Dec. 26, 2013

(54) MOVING PICTURE ENCODING APPARATUS, MOVING PICTURE ENCODING METHOD, AND MOVING PICTURE ENCODING PROGRAM, AND MOVING PICTURE DECODING APPARATUS, MOVING PICTURE DECODING METHOD, AND MOVING PICTURE DECODING PROGRAM

(71) Applicant: JVC KENWOOD Corporation, Yokohama-shi (JP)

(72) Inventor: Ichiro ANDO, Yokohama-shi (JP)

(73) Assignee: JVC KENWOOD Corporation, Yokohama-shi (JP)

(21) Appl. No.: 13/916,145

(22) Filed: Jun. 12, 2013

Related U.S. Application Data
(63) Continuation of application No. PCT/JP2011/006796, filed on Dec. 5, 2011.

(30) Foreign Application Priority Data
Dec. 17, 2010 (JP) 2010-282112
Dec. 17, 2010 (JP) 2010-282113

(51) Int. Cl. H04N 7/26

(52) U.S. Cl. CPC H04N 19/00218
USPC 382/233; 382/236

(57) ABSTRACT

A prediction mode selection unit selects, before a pixel subject to encoding is encoded, a prediction mode used to encode the pixel subject to encoding, using a local decoded value of a pixel on a line preceding a line including the pixel subject to encoding by at least 1 line in the order of encoding and in accordance with a predetermined conditional expression, and determines a prediction mode index corresponding to the selected prediction mode. A prediction mode index storage unit stores the prediction mode index. A prediction unit generates a predicted value for the pixel subject to encoding, based on the prediction mode index for the pixel subject to encoding read from the prediction mode index storage unit and using local decoded values of a plurality of adjacent pixels.

### BACKGROUND OF THE INVENTION

1. Field of the Invention

The present invention relates to a technology of encoding and decoding a moving picture and, more particularly, to a technology of encoding and decoding a moving picture by using pixel-based prediction encoding.

2. Description of the Related Art

Compression encoding is known as a technique to store and transfer images efficiently by reducing the amount of information utilizing correlation that occurs within an image. Encoding schemes based on ISO/IEC10918-1 (popularly known as JPEG), ISO/IEC14495-1 (popularly known as JPEG-LS), etc. are known. JPEG is designed to reduce the amount of information by performing discrete cosine transform in each block of 8×8 pixels and subjecting a weighted and quantized DCT coefficient to variable length encoding. Meanwhile, JPEG-LS is designed to reduce the amount of information by determining a predicted value for each pixel, using a plurality of adjacent local decoded pixels, quantizing a prediction error, and subjecting the quantized predicted error to variable length encoding.

Schemes designed to determine a predicted value for each pixel, using a plurality of adjacent local decoded pixels, and encoding a prediction error are generally known as Differential Pulse Code Modulation (DPCM) schemes. In comparison to JPEG, which is based on 8×8 pixel DCT, DPCM requires a relatively small scale for implementation.

Non-patent document 1 teaches a JPEG-LS scheme designed to refer to a plurality of adjacent pixels, to select one of a plurality of prediction modes according to a predefined conditional expression, and to select one pixel value from the plurality of adjacent pixels based on the selected prediction mode or determine a predicted value by performing a predetermined calculation. By configuring the encoding end and the decoding end to select one of a plurality of prediction modes according to the same conditional expression, and determining a predicted value accordingly, there is no need to encode information on the selected prediction mode so that information can be encoded efficiently.

Generally, predictive encoding assumes that a prediction error is normally small and is designed such that a smaller prediction error is quantized at finer resolution than a larger prediction error (non-linear quantization), and a shorter code is assigned to a smaller prediction error than a larger prediction error (variable length encoding). This is in an attempt to improve image quality by reducing coding distortion and to improve coding efficiency. It is therefore important to select a prediction mode appropriately and reduce a prediction error accordingly.

To address this, there is proposed, as in non-patent document 2, a scheme designed to identify downward sloping and upward sloping edges in addition to horizontal and vertical edges, calculate a predicted value by a method suited to the result of identification, and perform encoding and decoding accordingly.
[non-patent document 1] “LOCO-I: a low complexity, context-based, lossless image compression algorithm”, IEEE Data compression conference, March-April 1996.
[non-patent document 2] “Gradient Based Predictive Coding for Lossless Image Compression”, IEICE TRANS. INE&SYST. VOL. E89-D, NO. 7, Jul. 2006.

Where the prediction scheme as described in non-patent document 1 or non-patent document 2 is used to quantize a prediction error such that certain encoding distortion is permitted for the purpose of visual perception, different results are yielded at the encoding end and at the decoding end if adjacent pixels are used for selection of a prediction mode and determination of a predicted value. This is addressed by using adjacent local decoded pixels. This eliminates the need to encode information on a selected prediction mode for the purpose of using a quantized predicted error and so enables efficient encoding. In other words, a prediction mode is selected by using local decoded pixels adjacent to a pixel subject to encoding. A predicted value is defined according to the selected prediction mode, and a prediction error is identified and encoded. Plus, the encoded prediction error is locally decoded and the resultant local decoded pixel value is stored in a memory.

Local decoded pixels used for selection of a prediction mode and for definition of a predicted value based on the selected prediction mode include the pixel immediately to the left which is immediately previously encoded. For this reason, computation related to selection of a prediction mode, computation related to calculation of a predicted value based on the selected prediction mode, computation related to calculation of a prediction error based on the predicted value, computation related to quantization and inverse quantization based on the prediction error, computation related to calculation of a local decoded pixel based on the prediction value and the inverse quantized value, etc. need be performed in succession and completed before the next pixel is processed. Because the local decoded value of the pixel immediately to the left is used for selection of a prediction mode and calculation of a predicted value, none of the computation steps can be run in parallel.

For encoding of a moving picture, a large number of computation steps for each pixel need be processed in a very short period of time. For example, a pixel need be processed in about 13. 4 [nsec] in the case of a moving picture with a screen size of 1920×1080 and a frame rate of 30 Hz. Successive processing of a large number of computation steps in a short period of time requires a high-speed computing unit, which increases the cost of implementation of an encoding apparatus or a decoding apparatus or makes implementation difficult. Provisions for the purpose of reducing a prediction error such as selection from a large number of prediction modes or increase in the volume of computation related to selection of a prediction mode require a computing unit of even higher speed.

For example, non-patent document 1 teaches detecting horizontal and vertical edges according to a conditional expression and selecting one of three prediction modes. Non-patent document 2 teaches detecting horizontal and vertical edges, and downward sloping and upward sloping edges according to a conditional expression and selecting one of four prediction modes. The larger the number of prediction modes, the larger the volume of computation. This will require a computing unit of even higher speed and presents a serious problem of implementation in applying an encoding apparatus or a decoding apparatus to a moving picture.

### SUMMARY OF THE INVENTION

The present invention addresses the aforementioned issue, and a purpose thereof is to provide a technology capable of selecting from a larger number of prediction modes and reducing the volume of computation related to selection of a prediction mode.

To address the aforementioned issue, the moving picture encoding apparatus according to an embodiment of the present invention comprises: a prediction mode selection unit (106) configured to select, before a pixel subject to encoding is encoded, a prediction mode used to encode the pixel subject to encoding, using a local decoded value of a pixel on a line preceding a line including the pixel subject to encoding by at least 1 line in the order of encoding and in accordance with a predetermined conditional expression, and configured to determine a prediction mode index corresponding to the selected prediction mode; a prediction mode index storage unit (107) configured to store the prediction mode index; a prediction unit (108) configured to generate a predicted value for the pixel subject to encoding, based on the prediction mode index for the pixel subject to encoding read from the prediction mode index storage unit (107) and using local decoded values of a plurality of adjacent pixels; and a prediction error encoding unit (102) configured to encode a prediction error value obtained by subtracting the predicted value for the pixel subject to encoding from the value of the pixel subject to encoding.

Another embodiment of the present invention relates to a moving image encoding method. The method comprises: selecting, before a pixel subject to encoding is encoded, a prediction mode used to encode the pixel subject to encoding, using a local decoded value of a pixel on a line preceding a line including the pixel subject to encoding by at least 1 line in the order of encoding and in accordance with a predetermined conditional expression, and determining a prediction mode index corresponding to the selected prediction mode; storing the prediction mode index in a memory; generating a predicted value for the pixel subject to encoding, based on the prediction mode index for the pixel subject to encoding read from the memory and using local decoded values of a plurality of adjacent pixels; and encoding a prediction error value obtained by subtracting the predicted value for the pixel subject to encoding from the value of the pixel subject to encoding.

The moving picture decoding apparatus according to an embodiment of the present invention comprises: a prediction selection unit (304) configured to select, before a pixel subject to decoding is decoded, a prediction mode used to decode the pixel subject to decoding, using a decoded value of a pixel on a line preceding a line including the pixel subject to decoding by at least 1 line in the order of decoding and in accordance with a predetermined conditional expression, and configured to determine a prediction mode index corresponding to the selected prediction mode; a prediction mode index storage unit (305) configured to store the prediction mode index; a prediction unit (306) configured to generate a predicted value for the pixel subject to decoding, based on the prediction mode index for the pixel subject to decoding read from the prediction mode index storage unit (305) and using decoded values of a plurality of adjacent pixels; and an adder unit (302) configured to decode the pixel subject to decoding by adding the predicted value of the pixel subject to decoding and a decoded prediction error value obtained by decoding a predicted error code for the pixel subject to decoding.

Still another embodiment of the present invention relates to a moving picture decoding method. The method comprises: selecting, before a pixel subject to decoding is decoded, a prediction mode used to decode the pixel subject to decoding, using a decoded value of a pixel on a line preceding a line including the pixel subject to decoding by at least 1 line in the order of decoding and in accordance with a predetermined conditional expression, and determining a prediction mode index corresponding to the selected prediction mode; storing the prediction mode index in a memory; generating a predicted value for the pixel subject to decoding, based on the prediction mode index for the pixel subject to decoding read from the memory and using decoded values of a plurality of adjacent pixels; and decoding the pixel subject to decoding by adding the predicted value of the pixel subject to decoding and a decoded prediction error value obtained by decoding a predicted error code for the pixel subject to decoding.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing the configuration of a moving picture encoding apparatus according to an embodiment;

FIG. 2 shows a method of predicting a pixel in the JPEG-LS scheme;

FIG. 3 shows a first algorithm according to the embodiment for predicting a pixel subject to encoding;

FIGS. 4A-4D show the operation of the first prediction algorithm performed when a horizontal edge is identified around the current pixel;

FIGS. 5A-5D show the operation of the first prediction algorithm performed when a vertical edge is identified around the current pixel;

FIG. 6 shows a second prediction algorithm according to the embodiment for predicting a pixel subject to encoding;

FIGS. 7A-7D show the operation of the second prediction algorithm performed when a horizontal edge is identified around the current pixel;

FIGS. 8A-8D show the operation of the second prediction algorithm performed when a vertical edge is identified around the current pixel;

FIGS. 9A-9D show the operation of the second prediction algorithm performed when a downward sloping edge is identified around the current pixel;

FIGS. 10A-10D show the operation of the second prediction algorithm performed when an upward sloping edge is identified around the current pixel;

FIG. 11 shows a third prediction algorithm according to the embodiment for predicting a pixel subject to encoding;

FIG. 12 is a flowchart illustrating the image encoding process by the moving picture encoding apparatus of FIG. 1;

FIG. 13 is a block diagram showing the configuration of the moving picture decoding apparatus according to the embodiment; and

FIG. 14 is a flowchart illustrating the image decoding process by the moving picture decoding apparatus of FIG. 13.

### DETAILED DESCRIPTION OF THE INVENTION

The invention will now be described by reference to the preferred embodiments. This does not intend to limit the scope of the present invention, but to exemplify the invention.

A description will be given of embodiments of the present invention with reference to the drawings.

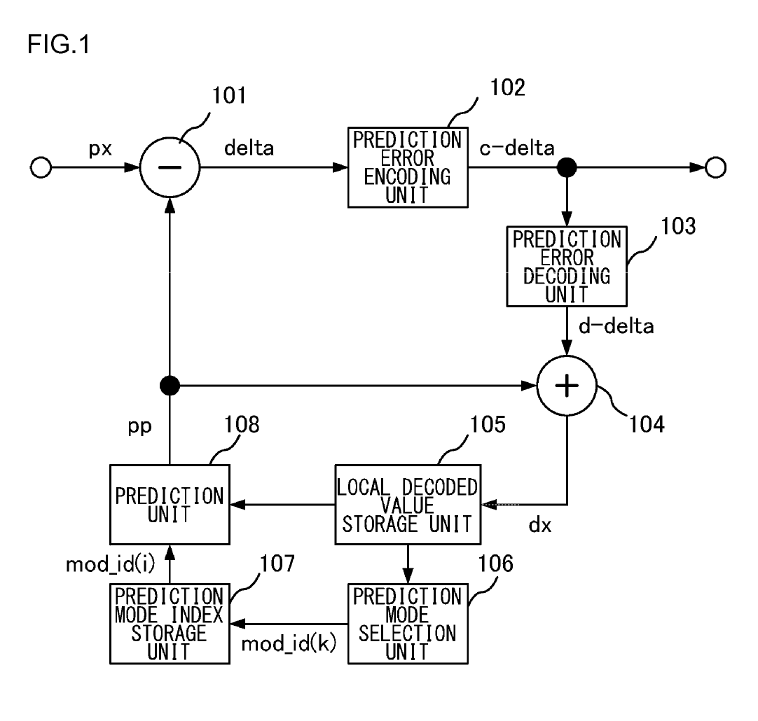

FIG. 1 is a block diagram showing the configuration of a moving picture encoding apparatus according to an embodiment. The moving picture encoding apparatus 1 includes a subtraction unit 101, a prediction error encoding unit 102, a prediction error decoding unit 103, an adder unit 104, a local decoded value storage unit 105, a prediction mode selection unit 106, a prediction mode index storage unit 107, and a prediction unit 108.

Pixels forming an image are input to the moving picture encoding apparatus such that pixels are successively subject to prediction and encoding, starting with the top left pixel and proceeding rightward, and continuing from the pixel at the right edge to the pixel at the left edge in the line immediately below. For example, 8 bits are assigned to each pixel.

The subtraction unit 101 subtracts a predicted value pp supplied from the prediction unit 108 from an input current pixel value px and outputs a resultant prediction error value delta.

The prediction error encoding unit 102 subjects the prediction error value delta supplied from the subtraction unit 101 to 6-bit non-linear quantization so as to output a prediction error code c-delta. A prediction error need not be encoded by non-linear quantization. For example, a prediction error may be subject to linear quantization, or a prediction error value or a quantized value thereof may be subject to variable encoding. Alternatively, other encoding schemes may be used.

The prediction error decoding unit 103 subjects the prediction error code c-delta from the prediction error encoding unit 102 to inverse quantization so as to output a prediction error decoded value d-delta.

The adder unit 104 adds the prediction error decoded value d-delta supplied from the prediction error decoding unit 103 to the predicted value pp supplied from the prediction unit 108 so as to output a local decoded value dx of a current pixel.

The local decoded value storage unit 105 stores, for the purpose of subjecting a pixel encoded later (in the future) to prediction, the local decoded value dx supplied from the adder unit 104 at least for a period of time until all pixels, which are scheduled to be subsequently encoded and for which the local decoded pixel value dx is possibly used for selection of a prediction mode and calculation of a predicted value, have been encoded.

The prediction mode selection unit 106 reads, for the purpose of selecting a prediction mode for a subsequently encoded pixel k, a plurality of local decoded pixel values from the local decoded value storage unit 105 so as to output a prediction mode index mod_id(k) indicating a selected prediction mode, based on a predetermined conditional expression determined by a prediction algorithm.

The prediction mode index storage unit 107 stores the prediction mode index mod_id(k) for the subsequently encoded pixel k supplied from the prediction mode selection unit 106 at least for a period of time until corresponding pixels have been encoded.

The prediction unit 108 reads the prediction mode index mod_id(i) for a current pixel i from the prediction mode index storage unit 107. The prediction unit 108 determines a predicted value pp for the current pixel i according to the prediction mode identified by mod_id(i), by using a plurality of local decoded pixel values read from the local decoded value storage unit 105, and outputs the predicted value pp.

The process performed by the prediction mode selection unit 106 to select a prediction mode for a subsequently encoded pixel k and store the prediction mode index mod_id(k) indicating the selected prediction mode in the prediction mode index storage unit 107 (referred to as “prediction mode selection process”) and the process performed by the prediction unit 108 to read the prediction mode index mod_id(i) for a current pixel i from the prediction mode index storage unit 107 so as to determine a predicted value pp of the current pixel i in the prediction mode identified by mod_id(i) (referred to as “predicted value calculation process”) proceed in parallel.

By not using a local decoded value of a pixel encoded immediately before the current pixel subject to encoding, the prediction mode selection process by the prediction mode selection unit 106 can be performed in advance of the predicted value calculation process by the prediction unit 108. Thus, the prediction mode selection process and the predicted value calculation process can be performed in parallel.

More specifically, in advance of the encoding of a current pixel subject to encoding by the prediction unit 108, the prediction mode selection unit 106 selects a prediction mode used to encode the current pixel according to a predetermined conditional expression, using a local decoded value of a pixel on a line preceding the current line by at least 1 line in the order of encoding. The prediction mode selection unit 106 outputs a prediction mode index indicating the selected prediction mode.

Before encoding an image, the local decoded value storage unit 105 and the prediction mode index storage unit 107 are initialized. These storage units are implemented by a memory. For example, the local decoded value storage unit 105 is initialized to contain 128, which is an intermediate value of a 8-bit pixel value. The prediction mode index storage unit 107 is initialized to contain a prediction mode index indicating the mode of prediction in the horizontal direction from the local decoded pixel immediately to the left.

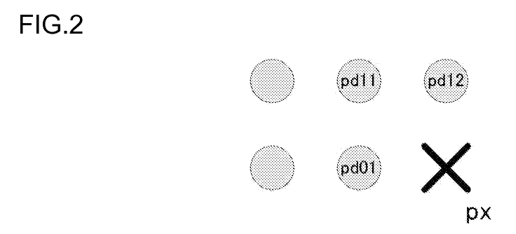

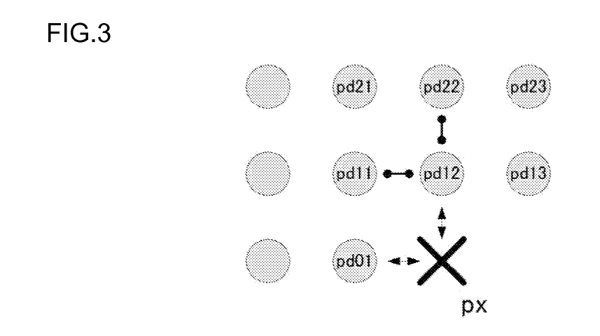

A detailed description will now be given of the prediction mode selection process by the prediction mode selection unit 106. By way of comparison, the method of predicting a pixel in the related-art JPEG-LS scheme will be described first with reference to FIG. 2, followed by a description of the prediction mode selection process by the prediction mode selection unit 106 according to the embodiment with reference to FIGS. 3-11.

FIG. 2 shows a method of predicting a pixel in the JPEG-LS scheme. A prediction mode mod_id for a pixel px subject to encoding is selected by using values of local decoded pixels including a pixel pd01 to the left, a pixel pd11 diagonally above, and a pixel pd12 immediately above, and in accordance with the following conditional expression.

if (pd11≧MAX(pd01,pd12))mod_id=0

elseif (pd11≦MIN(pd01,pd12))mod_id=1

else mod_id=2 (expression 201)

The predicted value pp of the pixel px subject to encoding is calculated based on the prediction mode mod_id and according to the following expression.

if (mod_id==0)pp=MIN(pd01,pd12)

elseif (mod_id==1)pp=MAX(pd01,pd12)

elseif (mod_id==2)pp=pd01+pd12−pd11 (expression 202)

where MIN( ) denotes computation to select the minimum value, and MAX( ) denotes computation to select the maximum value.

The prediction error delta is obtained by the following expression.

delta=px−pp (expression 203)

As indicated by expression (202), according to the prediction scheme of JPEG-LS, the pixel subject to encoding is predicted by selecting the local decoded pixel immediately to the left, the local decoded pixel immediately above, or a value calculated from the local decoded pixels immediately above, immediately to the left, and to the left and diagonally above, according to one of the three prediction modes.

As will be known from the conditional expression (expression 201) for determining a prediction mode, prediction from the local decoded pixel immediately to the left is generally selected when a horizontal edge is identified around the pixel subject to encoding. Prediction from the local decoded pixel immediately above is selected when a vertical edge is identified around the pixel subject to encoding. Prediction from a value calculated from the local decoded pixels immediately above, immediately to the left, and to the left and diagonally above, is selected when neither a horizontal edge nor a vertical edge is identified.

According to the method of predicting a pixel in the JPEG-LS scheme shown in FIG. 2, the mode of predicting the pixel px subject to encoding is determined by using the local decoded pixel pd01 immediately to the left encoded immediately preceding the pixel px subject to encoding. The local decoded pixel pd01 immediately to the left is not obtained until the encoding of the pixel px subject to encoding is started. Thus, the prediction method using the local decoded pixel immediately to the left requires successively performing the process of selecting a prediction mode and then the process of calculating a predicted value. Therefore, the prediction mode selection process and the predicted value calculation process cannot be performed in parallel.

The embodiment addresses the issue by selecting a prediction mode for the pixel px subject to encoding without using the local decoded pixel pd01 immediately to the left encoded immediately preceding the pixel px subject to encoding, and by using a local decoded pixel on a line preceding the line including the pixel px subject to encoding in the order of encoding by at least 1 line.

FIG. 3 shows a first algorithm according to the embodiment for predicting a pixel subject to encoding. FIG. 3 indicates that the local decoded pixel pd01 immediately to the left or the local decoded pixel pd12 immediately above is selected in accordance with the prediction mode and the selected value is defined as a predicted value for the current pixel px subject to encoding. Selection of the local decoded pixel is determined by the prediction mode index mod_idx determined by (expression 301)-(expression 303) below using the local decoded pixels pd11, pd12, and pd22 on the line preceding the line including the current pixel px in the order of encoding by 1 line or 2 lines.

According to the first prediction algorithm, the local decoded pixel pd01 immediately to the left of the current pixel px is not used to select a prediction mode, unlike the case of the related-art prediction method described in non-patent documents 1 and 2 and explained with reference to FIG. 2. Instead, the local decoded pixels pd11, pd12, and pd22 on the line preceding the line including the current pixel px in the order of encoding by 1 line or 2 lines are used. This allows selecting a prediction mode used to encode the current pixel px and determining the prediction mode index mod_id, before the calculation of the local decoded pixel pd01 immediately to the left is completed, i.e., before the encoding of the current pixel px is started. For example, subsequent to the completion of the calculation of the local decoded pixel pd12, the process of selecting a prediction mode used to encode the current pixel px may be performed in parallel with a series of processes related to prediction encoding of the next local decoded pixel pd13.

Because the process of selecting a prediction mode for the current pixel px need only be completed before the encoding of the current pixel px is started, the process of selecting a prediction mode for the current pixel px may be started at any point of time between the completion of the calculation of the local decoded pixels pd11, pd12, and pd22 used in the conditional expressions for determining the prediction mode and before the encoding of the current pixel px is started. In practice, it is preferable that the selection process be performed while the local decoded pixels pd11, pd12, and pd22 used in the conditional expressions for determining the prediction mode remain stored in the line memory.

The prediction mode mod_id for the current pixel px is selected based on (expression 301)-(expression 303) below, using the local decoded pixels pd11, pd12, and pd22 1 line or 2 lines before.

R1=abs(pd12−pd11) (expression 301)

R2=abs(pd12−pd22)+α (expression 302)

(α≧0)

if(R1<R2)mod_id=0

else mod_id=1 (expression 303)

where abs( ) denotes computation to determine an absolute value. α is a weighting value to prioritize an absolute difference R1 in the horizontal direction over an absolute difference R2 in the vertical direction.

The prediction value pp of the pixel px subject to encoding is calculated according to the prediction mode mod_id, using the following expression.

if(mod_id==0)pp=pd01

else pp=pd12 (expression 304)

The prediction error delta is given by the following.

delta=px−pp (expression 305)

According to the first prediction algorithm, the prediction mode index is a binary value and so can be represented by 1 bit. The prediction mode index storage unit 107 can be implemented by using a 1-bit memory generally capable of storing 1 line.

As can be known from conditional expressions (expression 301)-(expression 303) for determining the prediction mode and (expression 304) for calculating the predicted value, if the local decoded pixels pd11, pd12, and pd22 1 line or 2 lines before are given, and if the absolute difference R1 in the horizontal direction is smaller than the absolute difference R2 in the vertical direction, the current pixel px is predicted from the local decoded pixel pd01 immediately to the left. If the absolute difference R2 in the vertical direction is smaller than the absolute difference R1 in the horizontal direction, the current pixel px is predicted from the local decoded pixel pd12 immediately above.

As described above, the first prediction algorithm allows performing the process related to selection of the optimum prediction mode for the pixel subject to encoding in parallel with and in isolation from a series of processes related to prediction encoding of the pixel subject to encoding. By isolating the prediction mode selection process from the prediction encoding process, the prediction encoding process can be implemented in a relatively simpler, lower-speed computing unit than in the case of integrating the prediction encoding process with the prediction mode selection process.

A description will now be given of the operation of the first prediction algorithm performed when a horizontal or vertical edge is identified around the current pixel.

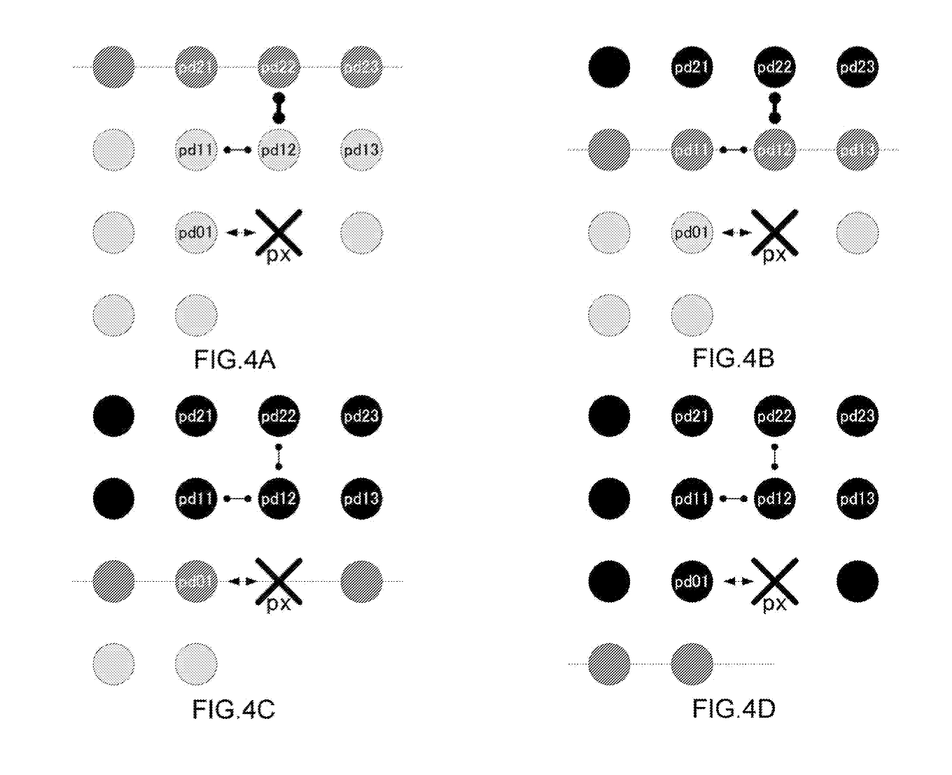

FIGS. 4A-4D show the operation of the first prediction algorithm performed when a horizontal edge is identified around the current pixel. Circles in the figures indicate pixels, and shades in the circles indicate pixel values. For simplicity, variation in the pixel values is represented by three shades including black, gray, and light gray. FIGS. 4A-4D show that horizontal lines vary from black, gray, to light gray from top to bottom. A horizontal edge is identified in one of the horizontal lines.

FIG. 4A shows that lines (not shown) above the pixels pd21, pd22, and pd23 in the first row are shaded in black, the line of pixels pd21, pd22, and pd23 in the first row is shaded in gray, and the line of pixels pd11, pd12, and pd13 in the second row and lines below are shaded in light gray. A horizontal edge is identified on the line of pixels pd21, pd22, and pd23 in the first row.

FIG. 4B shows that the line of pixels pd21, pd22, and pd23 in the first row and lines above are shaded in black, the line of pixels pd11, pd12, and pd13 in the second row is shaded in gray, and the line of pixels pd01 and px in the third row and lines below are shaded in light gray. A horizontal edge is identified in the line of pixels pd11, pd12, and pd13 in the second row.

FIG. 4C shows that line of pixels pd11, pd12, and pd13 in the second row and lines above are shaded in black, the line of pixels pd01 and px in the third row is shaded in gray, and line of pixels in the fourth row and lines below are shaded in light gray. A horizontal edge is identified in the line of pixels pd01 and px in the third row.

FIG. 4D shows that line of pixels pd01 and px in the third row and lines above are shaded in black, the line of pixels in the fourth row is shaded in gray, and lines (not shown) below the line of pixels in the fourth row are shaded in light gray. A horizontal edge is identified in the line of pixels in the fourth row.

In each of the figures, the size of the line ending with circles denotes the magnitude of the difference between local decoded pixels. The line ending with arrows at both ends indicate the adjacent local decoded pixel used to predict the current pixel px.

FIGS. 4A through 4D show how the absolute difference value R1 between the local decoded pixels pd11 and pd12 in the horizontal direction is compared with the value R2 obtained by adding the absolute difference value R2 between the local decoded values pd22 and pd12 in the vertical direction to a predefined weighting value α, the prediction mode in the horizontal direction (mod_id=0) is selected because R1 is smaller than R2, and the current pixel px is predicted from the local decoded pixel pd01 immediately to the left, in accordance with (expression 301) through (expression 303).

In the case of FIGS. 4A and 4B, the absolute difference between the pixels in the horizontal direction is smaller than the absolute difference between the pixels in the vertical direction so that R1<R2 holds and mod_id=0. Therefore, the local decoded pixel pd01 immediately to the left is selected as a predicted value for the current pixel px.

In the case of FIGS. 4C-4D, the absolute difference between the pixels in the horizontal direction is equal to the absolute difference between the pixels in the vertical direction. However, the weighting value α is added to the latter so that R1<R2 still holds and mod_id=0. Therefore, the local decoded pixel pd01 immediately to the left is selected as a predicted value for the current pixel px. By adding the weighting value α, erroneous determination is prevented from occurring in the case of FIGS. 4C and 4D.

Thus, in the presence of a horizontal edge, horizontal prediction is selected in any of the cases shown in FIGS. 4A-4D.

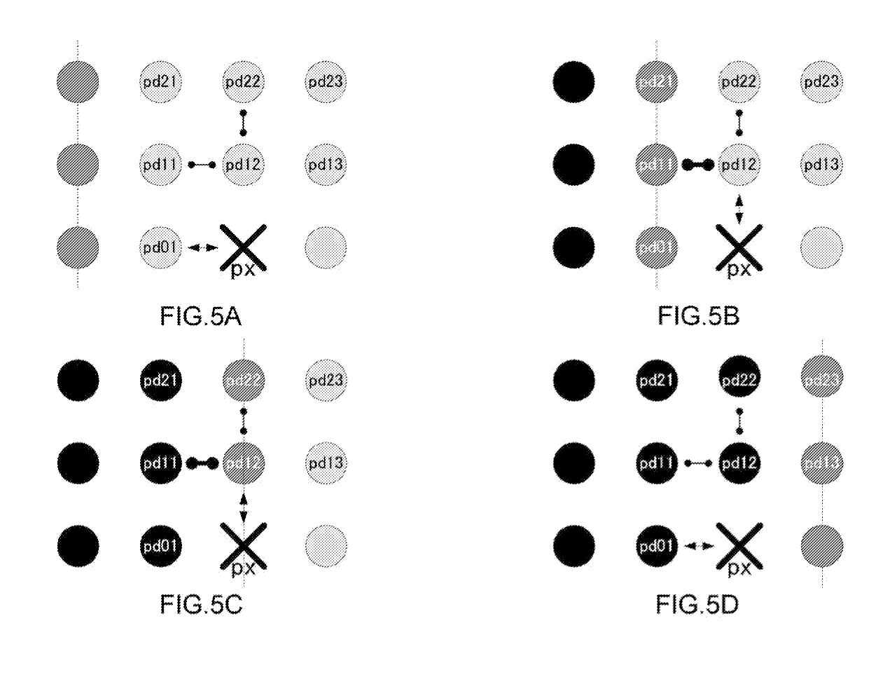

FIGS. 5A-5D show the operation of the first prediction algorithm performed when a vertical edge is identified around the current pixel. FIGS. 5A-5D show that vertical lines vary from black, gray, to light gray from left to right. A vertical edge is identified in one of the vertical lines.

FIG. 5A shows that lines (not shown) to the left of the line of pixels in the first column are shaded in black, the line of pixels in the first column is shaded in gray, and the line of pixels pd21, pd11, and pd01 and lines to the right are shaded in light gray. A vertical edge is identified in the line of pixels in the first column.

FIG. 5B shows that line of pixels in the first column and lines to the left are shaded in black, the line of pixels pd21, pd11 and pd01 in the second column is shaded in gray, and the line of pixels pd22, pd12, and px in the third column and lines to the right are shaded in light gray. A vertical edge is identified in the line of pixels pd21, pd11, and pd01 in the second column.

FIG. 5C shows that the line of pixels pd21, pd11, and pd01 in the second column and lines to the left are shaded in black, the line of pixels pd22, pd12, and px in the third column is shaded in gray, and the line of pixels pd23 and pd13 and lines to the right are shaded in light gray. A vertical edge is identified in the line of pixels pd22, pd12, and px in the third column.

FIG. 5D shows that the line of pixels pd22, pd12, and px in the third row and lines to the left are shaded in black, the line of pixels in the fourth column is shaded in gray, lines (not shown) to the right of the line of pixels pd23 and pd13 in the fourth column are shaded in light gray. A vertical edge is identified in the line of pixels pd23 and pd13 in the fourth column.

FIGS. 5A through 5D show how the absolute difference value R1 between the local decoded pixels pd11 and pd12 in the horizontal direction is compared with the value R2 obtained by adding the absolute difference value between the local decoded values pd22 and pd12 in the vertical direction to a predefined weighting value α, the prediction mode in the vertical direction (mod_id=1) is selected in the case of FIGS. 5B and 5C because R1 is not equal to or smaller than R2, and the current pixel px is predicted from the local decoded pixel pd12 immediately above. In the case of FIGS. 5A and 5D, the prediction mode in the horizontal direction (mod_id=0) is selected because R1 is smaller than R2, and the current pixel px is predicted from the local decoded pixel pd01 immediately to the left, in accordance with (expression 301) through (expression 303).

In the case of FIGS. 5B and 5C, the absolute difference between the pixels in the vertical direction is smaller than the absolute difference between the pixels in the horizontal direction so that R1>R2 holds and mod_id=1. Therefore, the local decoded pixel pd01 immediately above is selected as a predicted value for the current pixel px.

FIGS. 5A and 5B show that the absolute difference between the pixels in the vertical direction is equal to the absolute difference between the pixels in the horizontal direction. However, the weighting value α is added to the former so that R1<R2 holds and mod_id=0. Therefore, the local decoded pixel pd01 immediately to the left is selected as a predicted value for the current pixel px. Even if the prediction mode in the horizontal direction is selected in the case of FIG. 5A, prediction occurs between light gray pixels. In the case of FIG. 5D, prediction occurs between black pixels. Therefore, no serious prediction errors are created.

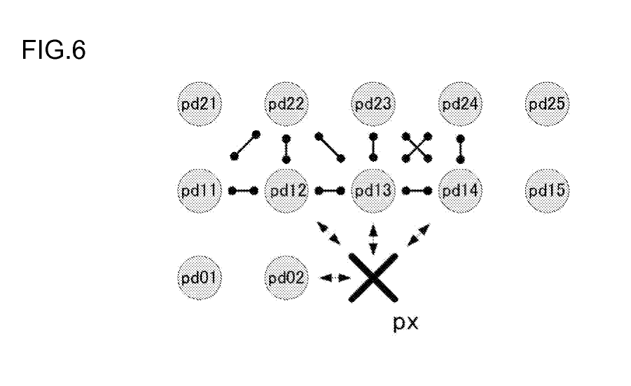

FIG. 6 shows a second prediction algorithm according to the embodiment for predicting a pixel subject to encoding. FIG. 6 indicates that the local decoded pixel pd02 immediately to the left, the local decoded pixel pd12 to the left and diagonally above, the local decoded pixel pd13 immediately above, or the local decoded pixel pd14 to the right and diagonally above is selected in accordance with the prediction mode and the selected value is defined as a predicted value for the current pixel px subject to encoding. Selection of the local decoded pixel is determined by the prediction mode index mod_id determined by (expression 601)-(expression 616) below using the local decoded pixels pd11, pd12, pd13, pd14, pd22, pd23, and pd24 on the line preceding the line including the current pixel px in the order of encoding by 1 line or 2 lines.

According to the second prediction algorithm, as in the first prediction algorithm, the local decoded pixel pd02 immediately to the left of the current pixel px is not used to select a prediction mode, unlike the case of the related-art prediction method described in non-patent documents 1 and 2 and explained with reference to FIG. 2. Instead, the local decoded pixels pd11, pd12, pd13, pd14, pd22, pd23, and pd24 on the line preceding the line including the current pixel px in the order of encoding by 1 line or 2 lines are used. This allows selecting a prediction mode used to encode the current pixel px and determining the prediction mode index mod_id, before the calculation of the local decoded pixel pd02 immediately to the left is completed, i.e., before the encoding of the current pixel px is started. For example, subsequent to the completion of the calculation of the local decoded pixel pd14, the process of selecting a prediction mode used to encode the current pixel px may be performed in parallel with a series of processes related to prediction encoding of the next local decoded pixel pd15.

The prediction mode mod_id for the current pixel px is selected based on (expression 601)-(expression 616) below, using the local decoded pixels pd11, pd12, pd13, pd14, pd22, pd23, and pd24 1 line or 2 lines before.

R11=abs(pd11−pd12) (expression 601)

R12=abs(pd12−pd13) (expression 602)

R13=abs(pd13−pd14) (expression 603)

R21=abs(pd22−pd13) (expression 604)

R22=abs(pd23−pd14) (expression 605)

R31=abs(pd22−pd12) (expression 606)

R32=abs(pd23−pd13) (expression 607)

R33=abs(pd24−pd14) (expression 608)

R41=abs(pd22−pd11) (expression 609)

R42=abs(pd24−pd13) (expression 610)

R1=MAX(R11,R12,R13) (expression 611)

R2=MAX(R21,R22)+α (expression 612)

R3=MAX(R31,R32,R33)+α (expression 613)

R4=MAX(R41,R42)+α (expression 614)

(α≧0)

Rmin=MIN(R1,R2,R3,R4) (expression 615)

if (R1==Rmin)mod_id=0

elseif (R2==Rmin)mod_id=1

elseif (R3==Rmin)mod_id=2

elseif (R4==Rmin)mod_id=3 (expression 616)

The predicted value pp of the pixel px subject to encoding is calculated based on the prediction mode mod_id and according to the following expression.

if (mod_id==0)pp=pd01

elseif (mod_id==1)pp=pd11

elseif (mod_id==2)pp=pd12

elseif (mod_id==3)pp=pd13 (expression 617)

The prediction error delta is obtained by the following expression.

delta=px−pp (expression 618)

As described above, the second prediction algorithm allows performing the process related to selection of the optimum prediction mode for the pixel subject to encoding in parallel with and in isolation from a series of processes related to prediction encoding of the pixel subject to encoding. By isolating the prediction mode selection process from the prediction encoding process, the prediction encoding process can be implemented in a relatively simpler, lower-speed computing unit than in the case of integrating the prediction encoding process with the prediction mode selection process.

The method described in non-patent document 2 teaches selecting a prediction mode by referring to downward sloping and upward sloping edges in addition to horizontal and vertical edges and calculating a predicted value accordingly. As such, the method requires a memory capable of storing at least 2 lines of local decoded pixels in order to calculate a predicted value. In contrast, the second prediction algorithm only requires a memory generally capable of storing 1 line of local decoded pixels to select a prediction mode by referring to downward sloping and upward sloping edges in addition to horizontal and vertical edges and to calculate a predicted value accordingly. Therefore, the required memory size can be reduced.

According to the second prediction algorithm, the prediction mode index is a quaternary value and so can be represented by 2 bits. The prediction mode index storage unit 107 can be implemented by using a 2-bit memory generally capable of storing 1 line, which also demonstrates that the second prediction algorithm provides satisfactory benefit of reduction in memory size.

A description will now be given of the operation of the second prediction algorithm performed when horizontal/vertical edges and downward sloping and upward sloping edges are identified around the current pixel. It should be noted that “downward sloping” is defined as a direction from top left to bottom right, and “upward sloping” is defined as a direction from top right to bottom left.

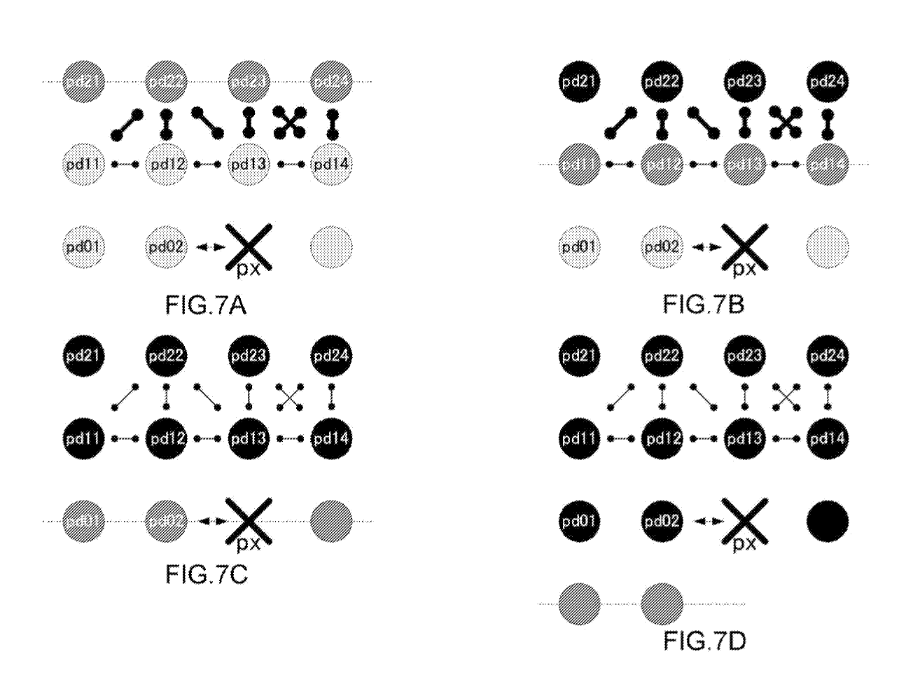

FIGS. 7A-7D show the operation of the second prediction algorithm performed when a horizontal edge is identified around the current pixel. FIGS. 7A-7D show that horizontal lines vary from black, gray, to light gray from top to bottom. A horizontal edge is identified in one of the horizontal lines.

FIG. 7A shows that lines (not shown) above the pixels pd21, pd22, pd23, and pd24 in the first row are shaded in black, the line of pixels pd21, pd22, pd23, and pd24 in the first row is shaded in gray, and the line of pixels pd11, pd12, pd13, and pd14 in the second row and lines below are shaded in light gray. A horizontal edge is identified in the line of pixels pd21, pd22, pd23, and pd24 in the first row.

FIG. 7B shows that the line of pixels pd21, pd22, pd23, and pd24 in the first row and lines above are shaded in black, the line of pixels pd11, pd12, pd13, and pd14 in the second row is shaded in gray, and the line of pixels pd01, pd02, and px in the third row and lines below are shaded in light gray. A horizontal edge is identified in the line of pixels pd11, pd12, pd13, and pd14 in the second row.

FIG. 7C shows that the line of pixels pd11, pd12, pd13, and pd14 in the second row and lines above are shaded in black, the line of pixels pd01, pd02, and px in the third row is shaded in gray, and the line (not shown) of pixels in the fourth row and lines below are shaded in light gray. A horizontal edge is identified in the line of pixels pd01, pd02, and px in the third row.

FIG. 7D shows that the line of pixels pd01, pd02, and px in the third row and lines above are shaded in black, the line of pixels in the fourth row is shaded in gray, and lines (not shown) below the pixels in the fourth row are shaded in light gray. A horizontal edge is identified in the line of pixels in the fourth row.

In each of the figures, the size of the line ending with circles denotes the magnitude of the difference between local decoded pixels. The line ending with arrows at both ends indicate the adjacent local decoded pixel used to predict the current pixel px.

FIGS. 7A through 7D show how an evaluation value R1 in the horizontal direction is determined to be the minimum value, the prediction mode in the horizontal direction (mod_id=0) is selected, and the current pixel px is predicted from the local decoded pixel pd02 immediately to the left, in accordance with (expression 601) through (expression 616).

By adding a predefined weighting value α in determining an evaluation value R2 in the downward sloping direction, an evaluation value R3 in the vertical direction, and an evaluation value R4 in the upward sloping direction, the evaluation value R1 in the horizontal direction is prioritized so that erroneous determination is prevented from occurring and the prediction mode in the horizontal direction is properly selected in the case of FIGS. 7C and 7D.

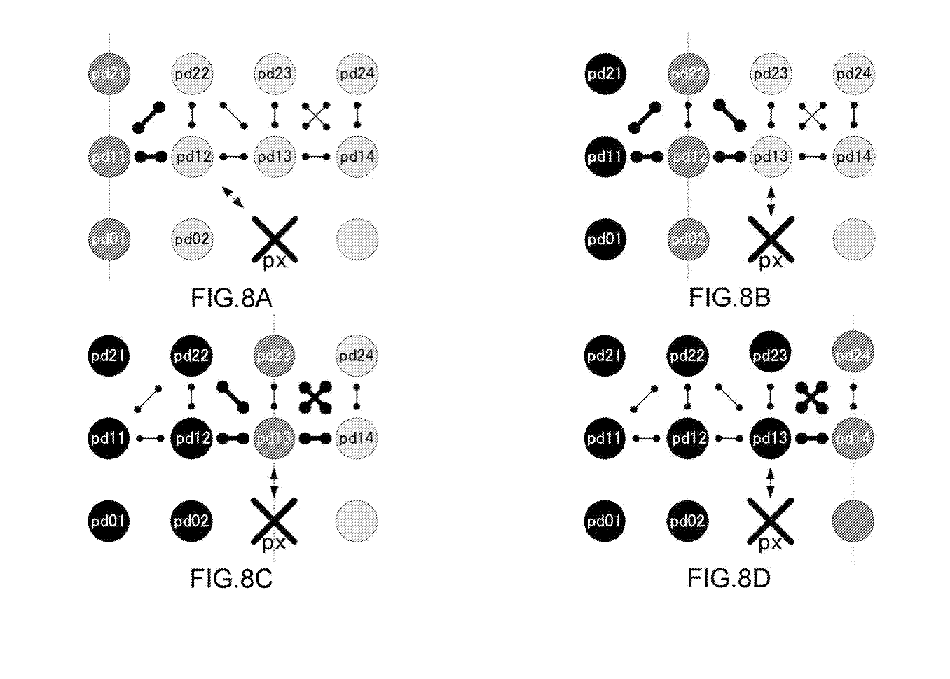

FIGS. 8A-8D show the operation of the second prediction algorithm performed when a vertical edge is identified around the current pixel. FIGS. 8A-8D show that vertical lines vary from black, gray, to light gray from left to right. A vertical edge is identified in one of the vertical lines.

FIG. 8A shows that lines (not shown) to the left of the line of pixels in the first column is shaded in black, the line of pixels pd21, pd11, and pd01 in the first column is shaded in gray, and the line of pixels pd22, pd12, and pd02 in the second column and lines to the right are shaded in light gray. A vertical edge is identified in the line of pixels pd21, pd11, and pd01 in the first column.

FIG. 8B shows that line of pixels pd21, pd11, and pd01 in the first column and lines to the left are shaded in black, the line of pixels pd22, pd12, and pd02 in the second column is shaded in gray, and the line of pixels pd23, pd13, and px in the third column and lines to the right are shaded in light gray. A vertical edge is identified in the line of pixels pd22, pd12, and pd02 in the second column.

FIG. 8C shows that the line of pixels pd22, pd12, and pd02 in the second column and lines to the left are shaded in black, the line of pixels pd23, pd13, and px in the third column is shaded in gray, and the line of pixels pd24 and pd14 in the fourth column and lines to the right are shaded in light gray. A vertical edge is identified in the line of pixels pd23, pd13, and px in the third column.

FIG. 8D shows that the line of pixels pd23, pd13, and px in the third column and lines to the left are shaded in black, the line of pixels in the fourth column is shaded in gray, and lines (not shown) to the right of the line of pixels pd24 and pd14 are shaded in light gray. A vertical edge is identified in the line of pixels pd24 and pd14 in the fourth column.

FIGS. 8B, 8C and 8D show how the evaluation value R3 in the vertical direction is determined to be the minimum value, the prediction mode in the vertical direction (mod_id=2) is selected, and the current pixel px is predicted from the local decoded pixel pd13 immediately above, in accordance with (expression 601) through (expression 616).

FIG. 8A shows how the evaluation value R2 in the downward sloping direction is determined to be the minimum value, the prediction mode in the downward sloping direction (mod_id=1) is selected, and the current pixel px is predicted from the local decoded pixel pd12 to the left and diagonally above. Selection of the prediction mode in the downward sloping direction does not cause a large prediction error because prediction occurs between light gray pixels in the case of FIG. 8A.

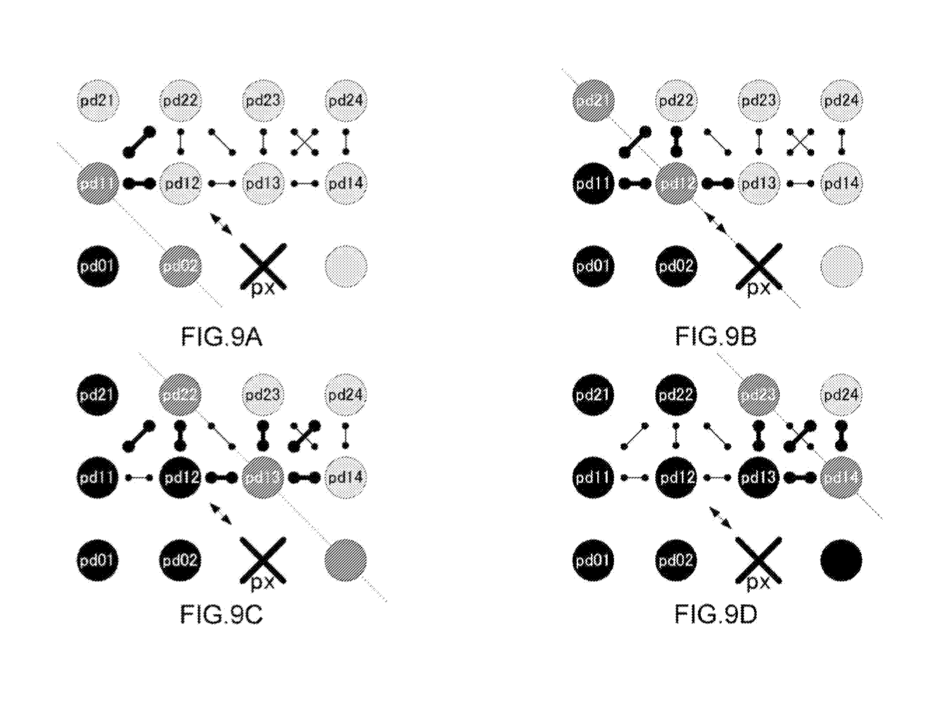

FIGS. 9A-9D show the operation of the second prediction algorithm performed when a downward sloping edge is identified around the current pixel. FIGS. 9A-9D show that downward sloping lines vary from black, gray, to light gray from top left to bottom right. A horizontal edge is identified in one of the downward sloping lines.

In FIGS. 7A-7D, the pixel values indicated by shades vary gradually in the vertical direction so that horizontal edges are identified. In FIGS. 9A-9D, the pixel values indicated by shades vary in the upward sloping direction so that downward sloping edges are identified. FIG. 9A shows that a downward sloping edge is identified in the downward sloping line of pixels pd11 and pd02 shaded in gray.

FIG. 9B shows that a downward sloping edge is identified in the downward sloping line of pixels pd21, pd12, and px shaded in gray. FIG. 9C shows that a downward sloping edge is identified in the downward sloping line of pixels pd22 and pd13 shaded in gray. FIG. 9D shows that a downward sloping edge is identified in the downward sloping line of pixels pd23 and pd14 shaded in gray.

FIGS. 9A through 9D show how the evaluation value R2 in the downward sloping direction is determined to be the minimum value, the prediction mode in the downward sloping direction (mod_id=1) is selected, and the current pixel px is predicted from the local decoded pixel pd12 to the left and diagonally above, in accordance with (expression 601) through (expression 616).

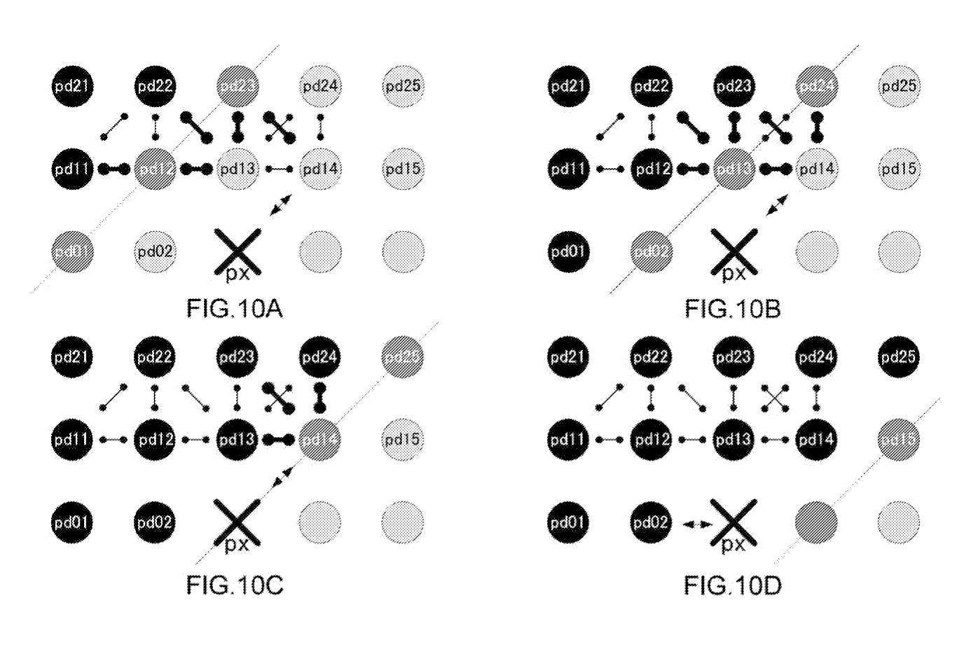

FIGS. 10A-10D show the operation of the second prediction algorithm performed when an upward sloping edge is identified around the current pixel. FIGS. 10A-10D show that upward sloping lines vary from black, gray, to light gray from top left to bottom right. A horizontal edge is identified in one of the upward sloping lines.

In FIGS. 8A-8D, the pixel values indicated by shades vary in the horizontal direction so that vertical edges are identified. In FIGS. 10A-10D, the pixel values indicated by shades vary in the downward sloping direction so that upward sloping edges are identified. FIG. 10A shows that an upward sloping edge is identified in the upward sloping line of pixels pd23, pd12, and pd01 shaded in gray.

FIG. 10B shows that an upward sloping edge is identified in the upward sloping line of pixels pd24, pd13, and pd02 shaded in gray. FIG. 10C shows that an upward sloping edge is identified in the upward sloping line of pixels pd25, pd14, and px shaded in gray. FIG. 10D shows that an upward sloping edge is identified in the upward sloping line of pixel pd15 shaded in gray.

FIGS. 10A, 10B and 10C show how the evaluation value R4 in the upward sloping direction is determined to be the minimum value, the prediction mode in the upward sloping direction (mod_id=3) is selected, and the current pixel px is predicted from the local decoded pixel pd14 to the right and diagonally above, in accordance with (expression 601) through (expression 616).

FIG. 10D shows how the evaluation value R1 in the horizontal direction is determined to be the minimum value, the prediction mode in the horizontal direction (mod_id=0) is selected, and the current pixel px is predicted from the local decoded pixel pd02 immediately to the left. Selection of the prediction mode in the horizontal direction does not cause a large prediction error because prediction occurs between black pixels in the case of FIG. 10D.

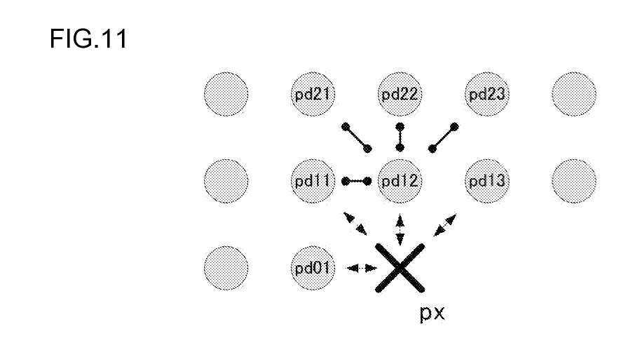

FIG. 11 shows a third prediction algorithm according to the embodiment for predicting a pixel subject to encoding. FIG. 11 indicates that the local decoded pixel pd01 immediately to the left, the local decoded pixel pd11 to the left and diagonally above, the local decoded pixel pd12 immediately above, or the local decoded pixel pd13 to the right and diagonally above is selected in accordance with the prediction mode and the selected value is defined as a predicted value for the current pixel px subject to encoding.

Selection of the local decoded pixel is determined by the prediction mode index mod_id determined by (expression 1101)-(expression 1106) below using the local decoded pixels pd11, pd12, pd21, pd22, and pd23 on the line preceding the line including the current pixel px in the order of encoding by 1 line or 2 lines.

According to the third prediction algorithm, as in the first and second prediction algorithms, the local decoded pixel pd01 immediately to the left of the current pixel px is not used. to select a prediction mode Instead, the local decoded pixels pd11, pd12, pd13, pd21, pd22, and pd23 on the line preceding the line including the current pixel px in the order of encoding by 1 line or 2 lines are used. This allows selecting a prediction mode used to encode the current pixel px and determining the prediction mode index mod_id, before the calculation of the local decoded pixel pd01 immediately to the left is completed, i.e., before the encoding of the current pixel px is started. For example, subsequent to the completion of the calculation of the local decoded pixel pd12, the process of selecting a prediction mode used to encode the current pixel px may be performed in parallel with a series of processes related to prediction encoding of the next local decoded pixel pd13.

The prediction mode mod_id is selected based on (expression 1101)-(expression 1106) below, using the local decoded pixels pd11, pd12, pd13, pd21, pd22, and pd23 1 line or 2 lines before.

R1=abs(pd11−pd12) (expression 1101)

R2=abs(pd21−pd12)+α (expression 1102)

R3=abs(pd22−pd12)+α (expression 1103)

R4=abs(pd23−pd12)+α (expression 1104)

(α≧0)

Rmin=MIN(R1,R2,R3,R4) (expression 1105)

if (R1==Rmin)mod_id=0

elseif (R2==Rmin)mod_id=1

elseif (R3==Rmin)mod_id=2

elseif (R4==Rmin)mod_id=3 (expression 1106)

The predicted value pp of the pixel px subject to encoding is calculated based on the prediction mode mod_id and according to the following expression.

if (mod_id==0)pp=pd01

elseif (mod_id==1)pp=pd11

elseif (mod_id==2)pp=pd12

elseif (mod_id==3)pp=pd13 (expression 1107)

The prediction error delta is obtained by the following expression.

delta=px−pp (expression 1108)

The advantages described as being provided by the second prediction algorithm also available in the third prediction algorithm. Unlike the second prediction algorithm shown in FIG. 6, however, the third prediction algorithm is configured such that the number of evaluation values for selecting a prediction mode is reduced. This makes the third prediction algorithm more advantageous than the second prediction algorithm in that the processing volume is smaller. However, because the number of evaluation values for selecting a prediction mode is smaller, erroneous determination occurs more frequently. It is therefore advised that the second prediction algorithm or the third prediction algorithm be selected by allowing for trade-off between the processing volume and the precision.

According to the third prediction algorithm, the prediction mode index is a quaternary value and so can be represented by 2 bits. The prediction mode index storage unit 107 can be implemented by using a 2-bit memory generally capable of storing 1 line, which also demonstrates that the third prediction algorithm provides satisfactory benefit of reduction in memory size. As compared with the case of the second prediction algorithm, the number of local decoded pixels used to determine the prediction mode index mod_id is smaller so that the prediction mode index mod_id can be determined in a more simplified manner.

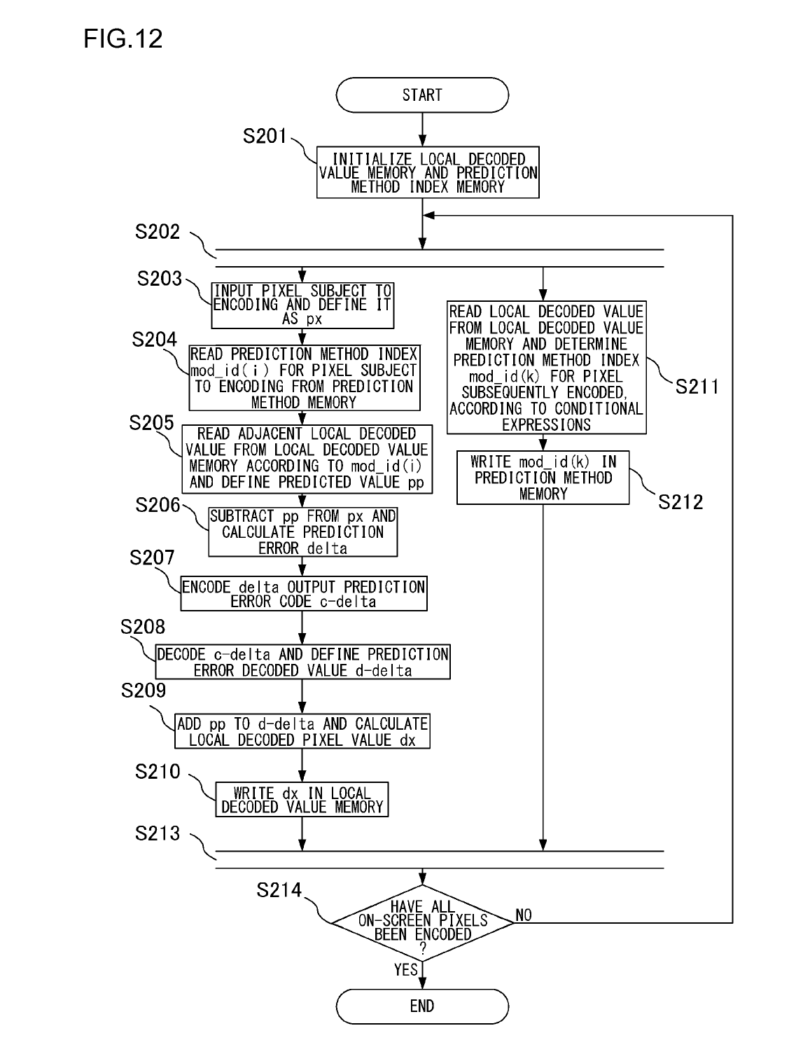

FIG. 12 is a flowchart for describing the image encoding process by the moving picture encoding apparatus of FIG. 1.

The local decoded value storage unit 105 and the prediction mode index storage unit 107 are initialized (S201).

The prediction unit 108 and the prediction mode selection unit 106 are controlled such that the predicted value calculation process from step S203 through step S210 and the prediction mode selection process from step S211 through step S212 are performed in parallel (S202).

A pixel i subject to encoding is input to the moving picture encoding apparatus and the pixel value of the pixel i subject to encoding is defined as the current pixel value px (S203).

The prediction unit 108 reads the prediction mode index mod_id(i) for the pixel i subject to encoding from the prediction mode index storage unit 107 (S204). The prediction unit 108 reads an adjacent local decoded pixel value from the local decoded value storage unit 105 in accordance with the prediction mode mod_id(i) and defines the read value as a predicted value pp (S205).

The subtraction unit 101 subtracts the predicted value pp from the current pixel value px and calculates a prediction error value delta (S206). The prediction error encoding unit 102 encodes the prediction error value delta and outputs a prediction error code c-delta (S207).

The prediction error decoding unit 103 decodes the prediction error code c-delta and determines a prediction error decoded value d-delta (S208). The adder unit 104 adds the predicted value pp to the prediction error decoded value d-delta so as to calculate a local decoded value dx (S209) and writes the local decoded value dx in the local decoded value storage unit 105 (S210).

Meanwhile, the prediction mode selection unit 106 reads a local decoded value from the local decoded value storage unit 105 and determines a prediction mode index mod_id(k) for a pixel k subsequently encoded in accordance with (expression 301) through (expression 303) if the first prediction algorithm is used, (expression 601) through (expression 616) if the second prediction algorithm is used, and (expression 1101) through (expression 1106) if the third prediction algorithm is used (S211).

The prediction mode selection unit 106 writes the prediction mode index mod_id(k) thus determined in the prediction mode index storage unit 107 (S212).

The system waits until the predicted value calculation process from step S203 through step S210 and the prediction mode selection process from step S211 through step S212 are both completed (S213).

A determination is made as to whether all on-screen pixels have been encoded. If all pixels have been encoded, the process is terminated. If any of the on-screen pixels has not been encoded, control returns to step S202 (S214).

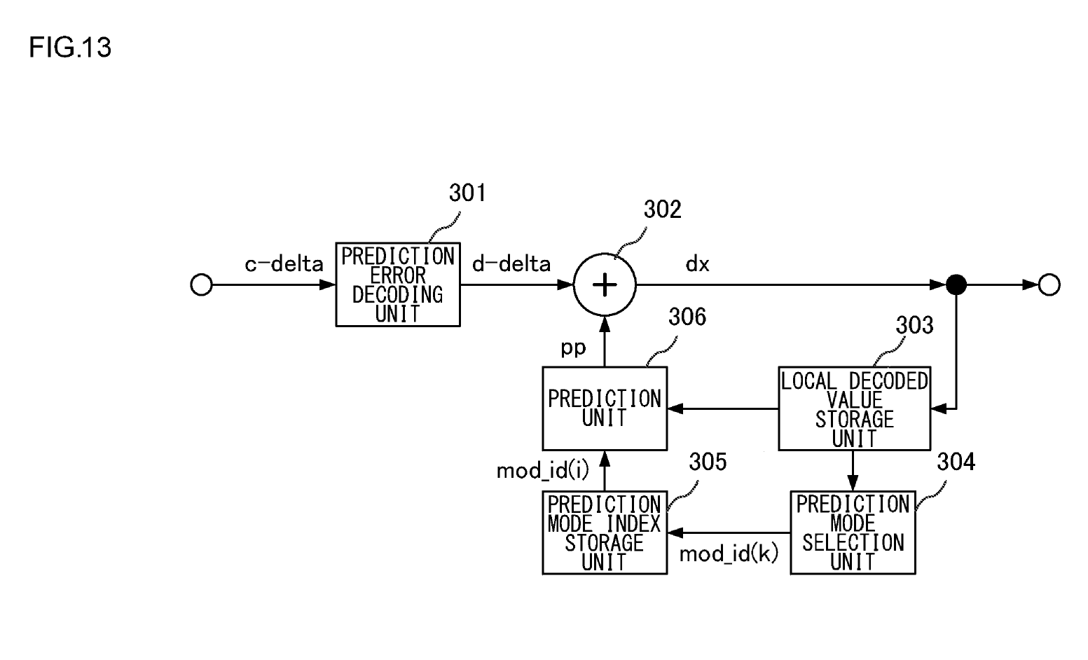

FIG. 13 is a block diagram showing the configuration of the moving picture decoding apparatus according to the embodiment. The moving picture decoding apparatus includes a prediction error decoding unit 301, an adder unit 302, a local decoded value storage unit 303, a prediction mode selection unit 304, a prediction mode index storage unit 305, and a prediction unit 306.

The prediction error decoding unit 301 subjects the input prediction error code c-delta to, for example, inverse quantization in association with the encoding process and outputs a prediction error decoded value d-delta.

The adder unit 302 adds the prediction error decoded value d-delta supplied from the prediction error decoding unit 301 to the predicted value pp supplied from the prediction unit 306 so as to output a local decoded value dx of a current pixel.

The local decoded value storage unit 303 stores, for the purpose of subjecting a pixel decoded later to prediction, the local decoded value dx at least for a period of time until all pixels, which are scheduled to be subsequently decoded and for which the local decoded pixel value dx is possibly used for selection of a prediction mode and calculation of a predicted value, have been decoded.

The prediction mode selection unit 304 reads, for the purpose of selecting a prediction mode for a subsequently decoded pixel k, a plurality of local decoded pixel values from the local decoded value storage unit 303 so as to output a prediction mode index mod_id(k) indicating a selected prediction mode, based on a predetermined conditional expression determined by a prediction algorithm.

The prediction mode index storage unit 305 stores the prediction mode index mod_id(k) for the subsequently encoded pixel k supplied from the prediction mode selection unit 304 at least for a period of time until corresponding pixels k have been decoded.

The prediction unit 306 reads the prediction mode index mod_id(i) for a current pixel i from the prediction mode index storage unit 305. The prediction unit 306 determines a predicted value pp for the current pixel i according to the prediction mode identified by mod_id(i), by using a plurality of local decoded pixel values read from the local decoded value storage unit 303, and outputs the predicted value pp. The prediction algorithm used in decoding is the same as the prediction algorithm used in encoding.

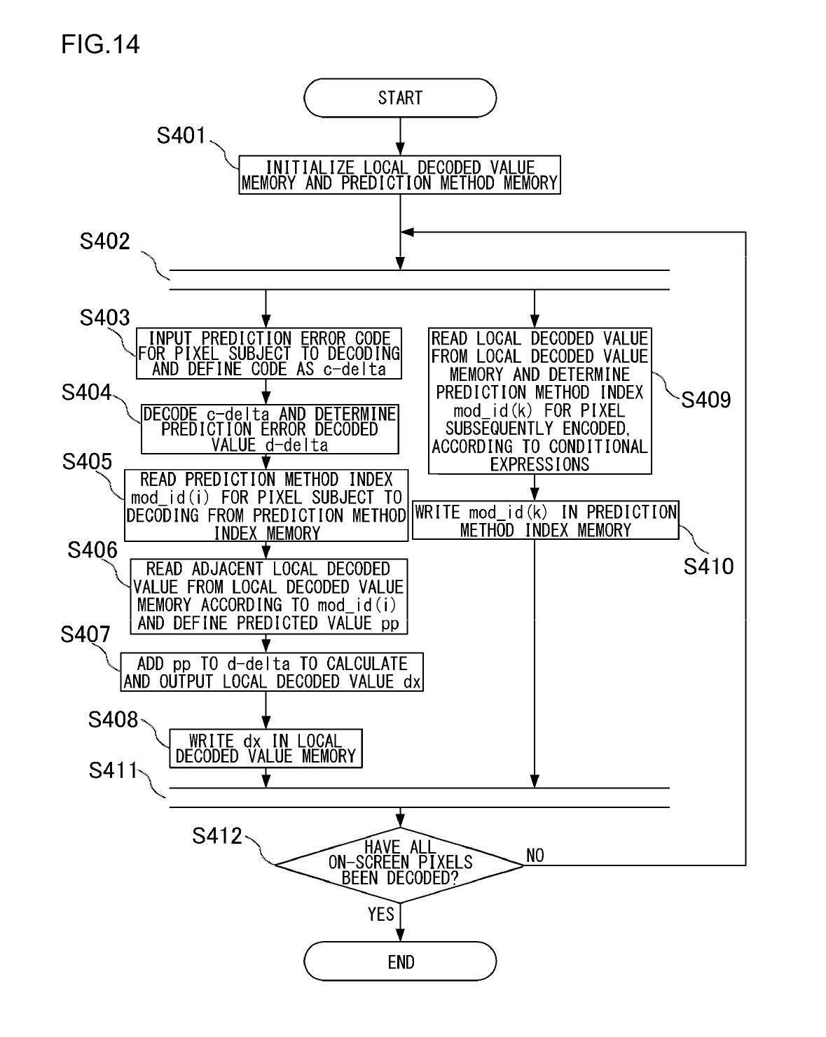

FIG. 14 is a flowchart illustrating the image decoding process by the moving picture decoding apparatus of FIG. 13. The decoding process by the moving picture decoding apparatus of FIG. 13 is performed in association with the encoding process by the moving picture encoding apparatus of FIG. 1.

The local decoded value storage unit 303 and the prediction mode index storage unit 305 are initialized (S401).

The prediction unit 306 and the prediction mode index storage unit 305 are controlled such that the predicted value calculation process from step S403 through step S408 and the prediction mode selection process from step S409 through step S410 are performed in parallel (S402).

The prediction error code for the pixel i subject to decoding is input to the moving picture decoding apparatus and the value of the prediction error code is defined as c-delta (S403).

The prediction error decoding unit 301 decodes the prediction error code c-delta and determines a prediction error decoded value d-delta (S404).

The prediction unit 306 reads the prediction mode index mod_id(i) for the pixel i subject to encoding from the prediction mode index storage unit 305 (S405). The prediction unit 306 reads an adjacent local decoded pixel value from the local decoded value storage unit 303 in accordance with the prediction mode mod_id(i) and defines the read value as a predicted value pp (S406).

The adder unit 302 adds the predicted value pp to the prediction error decoded value d-delta so as to calculate a local decoded value dx (S407) and writes the local decoded value dx in the local decoded value storage unit 303 (S408).

Meanwhile, the prediction mode selection unit 304 reads a local decoded value from the local decoded value storage unit 303 and determines a prediction mode index mod_id(k) for a pixel k subsequently encoded in accordance with (expression 301) through (expression 303) if the first prediction algorithm is used, (expression 601) through (expression 616) if the second prediction algorithm is used, and (expression 1101) through (expression 1106) if the third prediction algorithm is used (S409).

The prediction mode selection unit 304 writes the prediction mode index mod_id(k) thus determined in the prediction mode index storage unit 305 (S410).

The system waits until the predicted value calculation process from step S403 through step S408 and the prediction mode selection process from step S409 through step S410 are both completed (S411).

A determination is made as to whether all on-screen pixels have been encoded. If all pixels have been encoded, the process is terminated. If any of the on-screen pixels has not been encoded, control returns to step S402 (S412).

As described above, according to the embodiment of the present invention, computation related to selection of a prediction mode used in encoding or decoding a pixel is performed in advance of the encoding or decoding process by about 1 line. The index of the selected prediction mode is stored in a memory. When the pixel is encoded or decoded, the predicted value is calculated in accordance with the index of the prediction mode read from the memory.

In this way, computation related to selection of a prediction mode can be performed independently of and in parallel with a series of computation steps on each pixel. Therefore, even if selection is made from a large number of prediction modes or even if the volume of computation related to selection of a prediction mode is increased, there is no need for a high-speed computation unit so that a low-speed computation unit serves the purpose. Accordingly, the cost for implementation is reduced and the implementation is made easier.

By detecting downward sloping and upward sloping edges in addition to horizontal and vertical edges to select a prediction mode and reduce a prediction error accordingly, image quality is improved due to reduction in quantization distortion and encoding efficiency is improved due to reduction in the volume of generated codes.

The method of non-patent document 2 requires a memory capable of storing at least 2 lines of local decoded pixels in order to select a prediction mode by referring to downward sloping and upward sloping edges in addition to horizontal and vertical edges and to calculate a predicted value accordingly. As such, the method requires an increase of memory size in comparison with the scheme of non-patent document 1 that can be implemented by a memory capable of storing 1 line of local decoded pixels.

In contrast, by selecting a prediction mode in advance of the encoding or decoding by about 1 line as taught in the embodiment, a memory capable of storing 1 line of local decoded pixels is only needed to select a prediction mode by referring to downward sloping and upward sloping edges in addition to horizontal and vertical edges and to calculate a predicted value accordingly. Accordingly, the required memory size can be reduced so that the cost can be reduced accordingly. Further, the memory bandwidth can be reduced so that the power can be saved.

By using the first through third prediction algorithms in the decoding as well as in the encoding, the process related to selection of a proper prediction mode can be performed in isolation from a series of processes related to prediction encoding. Plus, the system can be implemented in a lower-speed computation unit. Further, the required memory size can be reduced.

The above-described processes related to encoding and decoding can of course be implemented by hardware-based apparatus for transmission, storage, or reception. Alternatively, the processes can be implemented by firmware stored in a read-only memory (ROM), a flash memory, etc., or by software on a computer, etc. The firmware program or the software program may be made available on, for example, a computer readable recording medium. Alternatively, the programs may be made available from a server via a wired or wireless network. Still alternatively, the programs may be made available in the form of data transmission over terrestrial or satellite digital broadcast systems.

Described above is an explanation based on an exemplary embodiment. The embodiment is intended to be illustrative only and it will be obvious to those skilled in the art that various modifications to constituting elements and processes could be developed and that such modifications are also within the scope of the present invention.

What is claimed is:

1. A moving picture encoding apparatus comprising:
a prediction mode selection unit configured to select, before a pixel subject to encoding is encoded, a prediction mode used to encode the pixel subject to encoding, using a local decoded value of a pixel on a line preceding a line including the pixel subject to encoding by at least 1 line in the order of encoding and in accordance with a predetermined conditional expression, and configured to determine a prediction mode index corresponding to the selected prediction mode;
a prediction mode index storage unit configured to store the prediction mode index;
a prediction unit configured to generate a predicted value for the pixel subject to encoding, based on the prediction mode index for the pixel subject to encoding read from the prediction mode index storage unit and using local decoded values of a plurality of adjacent pixels; and
a prediction error encoding unit configured to encode a prediction error value obtained by subtracting the predicted value for the pixel subject to encoding from the value of the pixel subject to encoding.

2. The moving picture encoding apparatus according to claim 1,
wherein the prediction mode selection unit selects the prediction mode in accordance with conditional expressions related to differences in the horizontal direction or the vertical direction between pixels on an immediately preceding line and a line further preceding by 1 line.

3. The moving picture encoding apparatus according to claim 2,
wherein the prediction mode selection unit further selects the prediction mode in accordance with conditional expressions related to differences in a diagonal direction between pixels on the immediately preceding line and the line further preceding by 1 line.

4. A moving picture encoding method comprising:
selecting, before a pixel subject to encoding is encoded, a prediction mode used to encode the pixel subject to encoding, using a local decoded value of a pixel on a line preceding a line including the pixel subject to encoding by at least 1 line in the order of encoding and in accordance with a predetermined conditional expression, and determining a prediction mode index corresponding to the selected prediction mode;
storing the prediction mode index in a memory;
generating a predicted value for the pixel subject to encoding, based on the prediction mode index for the pixel subject to encoding read from the memory and using local decoded values of a plurality of adjacent pixels; and
encoding a prediction error value obtained by subtracting the predicted value for the pixel subject to encoding from the value of the pixel subject to encoding.

5. A moving picture encoding program embedded on a non-transitory computer-readable recording medium, the program comprising:
a prediction mode index determining module configured to select, before a pixel subject to encoding is encoded, a prediction mode used to encode the pixel subject to encoding, using a local decoded value of a pixel on a line preceding a line including the pixel subject to encoding by at least 1 line in the order of encoding and in accordance with a predetermined conditional expression, and configured to determine a prediction mode index corresponding to the selected prediction mode;
a storage module configured to store the prediction mode index in a memory;
a predicted value generation module configured to generate a predicted value for the pixel subject to encoding, based on the prediction mode index for the pixel subject to encoding read from the memory and using local decoded values of a plurality of adjacent pixels; and
a prediction error value encoding module configured to encode a prediction error value obtained by subtracting the predicted value for the pixel subject to encoding from the value of the pixel subject to encoding.

6. A moving picture decoding apparatus comprising:
a prediction selection unit configured to select, before a pixel subject to decoding is decoded, a prediction mode used to decode the pixel subject to decoding, using a decoded value of a pixel on a line preceding a line including the pixel subject to decoding by at least 1 line in the order of decoding and in accordance with a predetermined conditional expression, and configured to determine a prediction mode index corresponding to the selected prediction mode;
a prediction mode index storage unit configured to store the prediction mode index;
a prediction unit configured to generate a predicted value for the pixel subject to decoding, based on the prediction mode index for the pixel subject to decoding read from the prediction mode index storage unit and using decoded values of a plurality of adjacent pixels; and
an adder unit configured to decode the pixel subject to decoding by adding the predicted value of the pixel subject to decoding and a decoded prediction error value obtained by decoding a predicted error code for the pixel subject to decoding.

7. The moving image decoding apparatus according to claim 6,
wherein the prediction mode selection unit selects the prediction mode in accordance with conditional expressions related to differences in the horizontal direction or the vertical direction between pixels on an immediately preceding line and a line further preceding by 1 line.

8. The moving image decoding apparatus according to claim 7,
wherein the prediction mode selection unit further selects the prediction mode in accordance with conditional expressions related to differences in a diagonal direction between pixels on the immediately preceding line and the line further preceding by 1 line.

9. A moving picture decoding method comprising:
selecting, before a pixel subject to decoding is decoded, a prediction mode used to decode the pixel subject to decoding, using a decoded value of a pixel on a line preceding a line including the pixel subject to decoding by at least 1 line in the order of decoding and in accordance with a predetermined conditional expression, and determining a prediction mode index corresponding to the selected prediction mode;
storing the prediction mode index in a memory;
generating a predicted value for the pixel subject to decoding, based on the prediction mode index for the pixel subject to decoding read from the memory and using decoded values of a plurality of adjacent pixels; and
decoding the pixel subject to decoding by adding the predicted value of the pixel subject to decoding and a decoded prediction error value obtained by decoding a predicted error code for the pixel subject to decoding.

10. A moving picture decoding program embedded on a non-transitory computer-readable recording medium, the program comprising:
a prediction mode index determining module configured to select, before a pixel subject to decoding is decoded, a prediction mode used to decode the pixel subject to decoding, using a decoded value of a pixel on a line preceding a line including the pixel subject to decoding by at least 1 line in the order of decoding and in accordance with a predetermined conditional expression, and configured to determine a prediction mode index corresponding to the selected prediction mode;
a prediction mode index storage module configured to store the prediction mode index in a memory;
a predicted value generation module configured to generate a predicted value for the pixel subject to decoding, based on the prediction mode index for the pixel subject to decoding read from the memory and using decoded values of a plurality of adjacent pixels; and
a decoding module configured to decode the pixel subject to decoding by adding the predicted value of the pixel subject to decoding and a decoded prediction error value obtained by decoding a predicted error code for the pixel subject to decoding.
